(19) United States
(12) Patent Application Publication
(10) Pub. No.: US 2015/0205697 A1
(43) Pub. Date: Jul. 23, 2015

(54) SOFTWARE DEVELOPMENT APPARATUS AND METHOD

(71) Applicant: TMAXSOFT. CO., LTD., Seongnam-si (KR)

(72) Inventors: Byung Bum Kim, Seongnam-si (KR); Sang Su Ha, Seongnam-si (KR); Han Kwang Lee, Seongnam-si (KR); Jin Hwan An, Seongnam-si (KR); Min Kyu Hwang, Seongnam-si (KR)

(73) Assignee: TMAXSOFT. CO., LTD., Seongnam-si (KR)

(21) Appl. No.: 14/228,202

(22) Filed: Mar. 27, 2014

(30) Foreign Application Priority Data
Jan. 23, 2014 (KR) 10-2014-0008417

(51) Int. Cl. G06F 11/36; G06F 9/44

(52) U.S. Cl. CPC G06F 11/368; G06F 8/71

(57) ABSTRACT

A method includes performing a check-out process of fetching a program to be modified from an operating space to a development space, performing a modification task on the checked-out program in the development space, selecting a target program of the operating space having a fetch relationship with the modified program when the modification task is completed, changing the selected target program so that the selected target program is fetched, performing simulations on the modified program through an association between the modified program and the target program, and performing a check-in process of updating contents of the modified program by incorporating the contents of the modified program into the operating space when program development is completed.

### RELATED APPLICATIONS

This application claims the benefit of Korean Patent Application No. 10-2014-0008417, filed on Jan. 23, 2014, which is hereby incorporated by references as if fully set forth herein.

### FIELD OF THE INVENTION

The present invention relates to a software development scheme and, more particularly, to a software development apparatus and method, which are suitable for logically separating and managing a program to be used in an operating environment and a program being developed in a single program execution space and at the same time mixing a program of an operating version and a program of a development version and testing the mixed program.

### BACKGROUND OF THE INVENTION

In order to assist the development and maintenance and repair of software, new methodologies and automation tools are being developed, and one of the methodologies and automation tools is a version management system. The version management system refers to a system for systematically managing software elements and software shapes which are changed over time owing to the correction of errors, a change of user requirements, and the improvement of a software function.

In general, a tool, such as subversion (SVN) for providing service intended for the management of a shape of a common repository, is used or a shape management program that performs a function similar to that of the tool is directly fabricated and used.

In most cases, however, only the history management of software in a common repository is supported, but a history management function for a personal repository is not sufficient. In order to test a developed product, products associated with the developed product needs to become up-to-date. To this end, the final test is performed by synchronizing a task space with a common repository through an update function. If it is sought to perform a test having a reference relationship (or a fetch relationship) with a program developed by another user, the developed product needs to be submitted to a common repository. Another user has the product updated and performs the test. In such a case, there is a problem in that a program being developed is incorporated into a common repository for test purposes.

Furthermore, if a test is performed on a program being developed in a task space in order to avoid incorporating the program into the common repository, it means that all the final products need to be present in a personal task space. In such a case, there is a problem in that all related programs need to be updated into the latest version or need to be checked out if a personal task space is not present.

### SUMMARY OF THE INVENTION

In view of the above, the present invention proposes a new software development scheme which is capable of overcoming the limits of the existing program version management and test method and performing simulations (or tests) on the final product of a written program prior to the submission of the final product.

Further, the present invention proposes a software development scheme which is capable of reducing the waste of hardware and human resources and also enhancing the productivity of software development by performing a software development project through a single program execution environment.

Technical objects to be achieved by the present invention are not limited to the aforementioned object, and other technical objects that have not been described above will become evident to those skilled in the art to which the present invention pertains from the following description.

In accordance with an aspect of the present invention, there is provided a software development apparatus, which includes a space management control unit configured to separately control and manage an operating space that is a space of a previously developed program and a virtual development space to be assigned to a developer, a program version control unit configured to update contents of a program into the operating space and manage a history of an existing program in a check-in process and control a version of a program in the development space when a checked-out program is modified, an execution file control unit configured to manage names of execution files of the programs of the operating space and the development space using delimiters so that the program of the operating space is distinguished from the program of the development space in a single program execution space, a simulation control unit configured to write a fetch relationship between the programs of the operating space and the development space so that the program of the operating space or the development space is selectively fetched when simulating a program being developed, fetch a target program, and perform a simulation operation on the target program, and a program information management unit configured to manage information about contents of the program being developed and appended data necessary to control a corresponding program.

In the exemplary embodiment, the space management control unit may manage a target space as the development space when deleting a program in the development space and manages a target space as the operating space when deleting a lock for the check-in process.

In the exemplary embodiment, the space management control unit may control a target space so that a program present in a space selected by a user is fetched when the program of the development space or the operating space is selectively executed for the simulation operation.

In the exemplary embodiment, the space management control unit may manage resources of a program through a check-in process and a check-out process and determines a state of a program based on information about a program lock used.

In the exemplary embodiment, the execution file control unit may add a predefined prefix or postfix to the name of the execution file of the program of the development space or changes a path of the execution file so that the name of the execution file of the program of the development space is distinguished from the name of the execution file of the program of the operating space when writing the program of the development space.

In the exemplary embodiment, the program being developed may be a modification program or a new program.

In accordance with another aspect of the exemplary embodiment of the present invention, there is provided a software development method, which includes performing a check-out process of fetching a program to be modified from an operating space to a development space, performing a modification task on the checked-out program in the development space, selecting a target program of the operating space having a fetch relationship with the modified program when the modification task is completed, changing the selected target program so that the selected target program is fetched, performing simulations on the modified program through an association between the modified program and the target program, and performing a check-in process of updating contents of the modified program by incorporating the contents of the modified program into the operating space when program development is completed.

In accordance with further another aspect of the exemplary embodiment of the present invention, there is provided a software development method, which includes performing a development task on a new program through a development space, selecting a target program of an operating space having a fetch relationship with the developed program when the development task is completed, changing the selected target program so that the selected target program is fetched, performing simulations on the developed program through an association between the developed program and the target program, and performing a check-in process of updating contents of the developed program by incorporating the contents of the developed program into the operating space when program development is completed.

### BRIEF DESCRIPTION OF THE DRAWINGS

The objects and features of the present invention will become apparent from the following description of embodiments given in conjunction with the accompanying drawings, in which:

FIG. 1 is an exemplary diagram showing separated spaces related to the present invention;

FIG. 2 is a configuration showing the entire system to which a software development apparatus of the present invention has been applied;

FIG. 3 is a diagram illustrating a process of performing a check-out process on a program in order for a developer to modify the program;

FIG. 4 is a diagram illustrating a process of performing a check-in process for updating a developed or modified program by incorporating the developed or modified program into an operating space;

FIG. 5 is a diagram illustrating a state in which programs in a development space and an operating space according to the present invention are logically classified and registered with a program execution space for an operation; and

FIG. 6 is a diagram illustrating a case where the operation of a program 2 and a development program are mixed and simulated when a developer modifies the program 2.

### DETAILED DESCRIPTION OF THE EMBODIMENTS

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to clearly understand the scope of the present invention. The present invention is defined by the claims.

Furthermore, in describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

Hereinafter, embodiments of the present invention will be described in detail with reference to the accompanying drawings which form a part hereof.

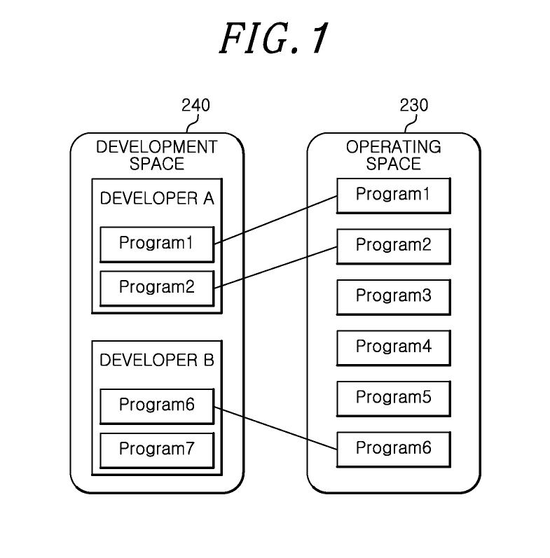

FIG. 1 is an exemplary diagram showing separated spaces related to the present invention.

Referring to FIG. 1, programs (e.g., a program 1 to a program 6) on which development has been completed and a check-in process has been performed may be present in an operating space 230, and programs (e.g., a program 1, a program 2, a program 6, and a program 7) that are being developed by developers (e.g., a developer A and a developer B) may be present in a development space 240.

The developers can perform a check-out process of fetching the existing programs present in the operating space 230 to the development space 240 and modify (or change) the programs or may register and develop new programs not present in the operating space 230. The developer can register (or incorporate) the program modified through the check-in process or the developed program with (or into) the operating space 230 and manage the program.

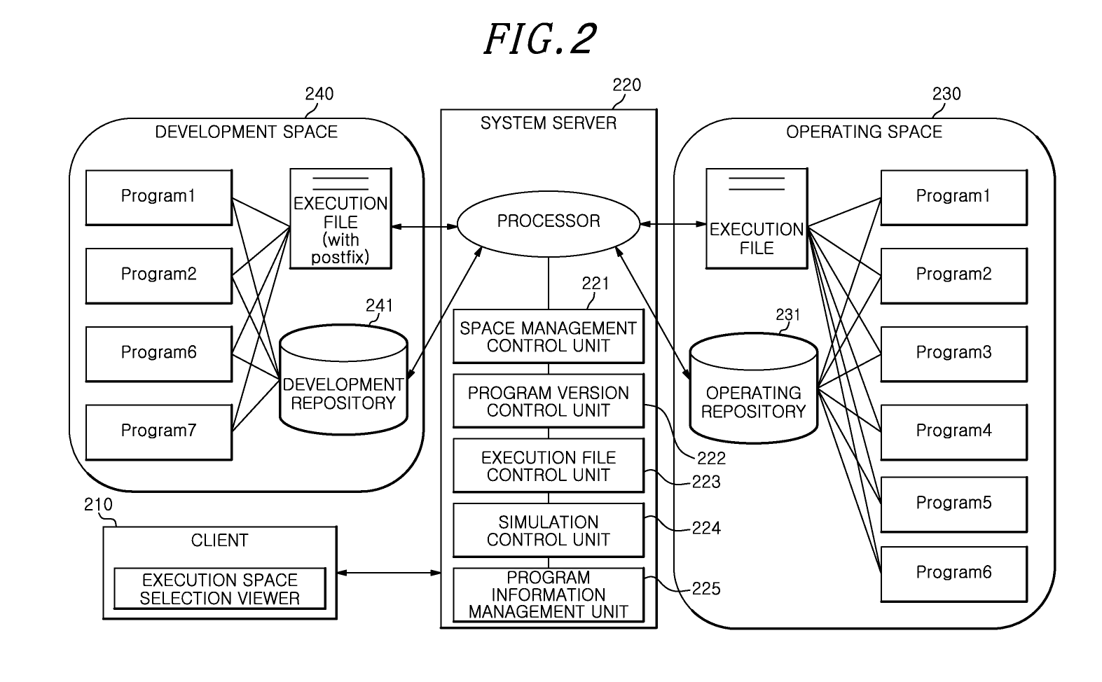

FIG. 2 is a configuration showing the entire system to which a software development apparatus of the present invention has been applied. The system may include a client 210, a system server 220, the operating space 230, the development space 240, and so on.

Referring to FIG. 2, the client 210 may include, for example, an execution space selection viewer and provide a function of generating various types of control instructions according to a developer interface that is generated for the development (or modification) of software and transferring the control instructions to the system server 220. Here, a developer (or a user) can determine whether to select the operating space 230 of a program (e.g., the program 2) to be modified through the execution space selection viewer or the development space 240.

The system server 220 may include a space management control unit 221, a program version control unit 222, an execution file control unit 223, a simulation control unit 224, a program information management unit 225, and so on.

The space management control unit 221 of the system server 220 can perform a function for dividing a target space in order to process tasks for each space, such a check-in process or a check-out process, and controlling and managing the divided spaces. The space management control unit 221 can provide the function based on information about each space because most of operations are executed in their target space when service, such as check-in, check-out, and simulations, is executed in the system server 220. That is, the space management control unit 221 can divide a target space into an operating space, that is, a space for a developed program, and a virtual development space to be assigned to a developer and control and manage the operating space and the virtual development space.

For example, in a check-in process, a target space may be changed and used. When deleting a program present in a development space, a target space may be managed as the development space. In a process of deleting a lock for a check-in process, a target space may be managed as an operating space. When deleting a program present in a development space during a check-in process, a target space may be managed as the development space. That is, the space management control unit 221 can provide a function of controlling the resources (e.g., a repository or an execution file) of a designated space.

Furthermore, in a simulation operation (or a test operation), programs present in a development space or an operating space are selectively executed in response to a user's choice. Here, the space management control unit 221 can control a target space so that the user can fetch a program present in a selected space.

That is, in accordance with the present invention, the space management control unit 221 provides a function for controlling and managing each space for development and an operation in processes, such as check-in, check-out, and simulations.

The program version control unit 222 manages the changes (or modifications) of each program. In the case of a check-in process, the program version control unit 222 updates the contents of a program of the operating space 230 and performs a task (i.e., a version history management function) for making the existing program as a history. If a program checked out from the operating space 230 to the development space 240 is modified, the program version control unit 222 can provide a function of controlling (e.g., incorporating the program or updating an execution file) the version of the program present in the development space 240. That is, the program version control unit 222 can manage and control the source code of each program for each software version.

Here, information about the particulars of already developed programs is stored and managed in an operating repository 231 within the operating space 230, and information about the particulars of programs that are being developed or modified is stored and managed in a development repository 241 within the development space 240.

The execution file control unit 223 can provide a function of managing the name of an execution file (e.g., a library name) as a delimiter so that a program present in the operating space 230 can be distinguished from a program present in the development space 240 in a single program execution space. That is, the execution file control unit 223 can manage execution files using postfix so that programs being driven and developed can coexist in a program execution space or using other various methods, such as methods of adding a predefined prefix or postfix to an execution file, changing, generating, or deleting the name of an execution file, and changing the path of an execution file so that the name of the execution file of a corresponding program can be distinguished from the operating space 230 when a program is written in the development space 240.

The simulation control unit 224 can provide a function of writing a fetch relationship (or a reference relationship) so that a program present in the operating space 230 or the development space 240 can be selectively fetched when simulating (or testing) a program being developed (e.g., a modification program or a new program) or of fetching a target program through the space management control unit 221.

For example, the simulation control unit 224 may change a fetch relationship so that the program 2 desired by the program 1 of the operating space 230 can be fetched in order to execute simulations and perform control so that a program present in a target space is selected through the space management control unit 221 and fetched. That is, assuming that the contents of the program 1 have been modified by checking out the program 1 and the program 2 and the program 1 have a fetch relationship, the simulation control unit 224 can fetch the program 2 from the operating space 230 to the development space 240 (copy to the development repository 241) in order to perform simulations on the modified program 1.

The program information management unit 225 can provide a function of managing information about the contents of a program being developed (e.g., a modified program or a new program) and appended data (e.g., metadata) necessary to control the corresponding program.

For example, if a program is fetched from the operating space 230 to the development space 240 through a check-out process, information about the program is written into the operating repository 231. Such data becomes information about the contents of the program. Here, a part, such as lock information written into the operating repository 231, becomes appended data necessary to control the program.

In accordance with the present invention, since operation and development shapes are separated and managed, an administrator can delete a development space having a relatively low importance according to his or her determination. The deletion of the development space may include a process of deleting the contents of a program from a development repository, a process of deleting an execution program present in the development space from a program execution space, and a process of initializing program lock information in the operating repository of an operating space.

A series of processes for modifying existing software or developing new software and incorporating the modified or new software into the operating space using the software development apparatus of the present invention are described in detail below.

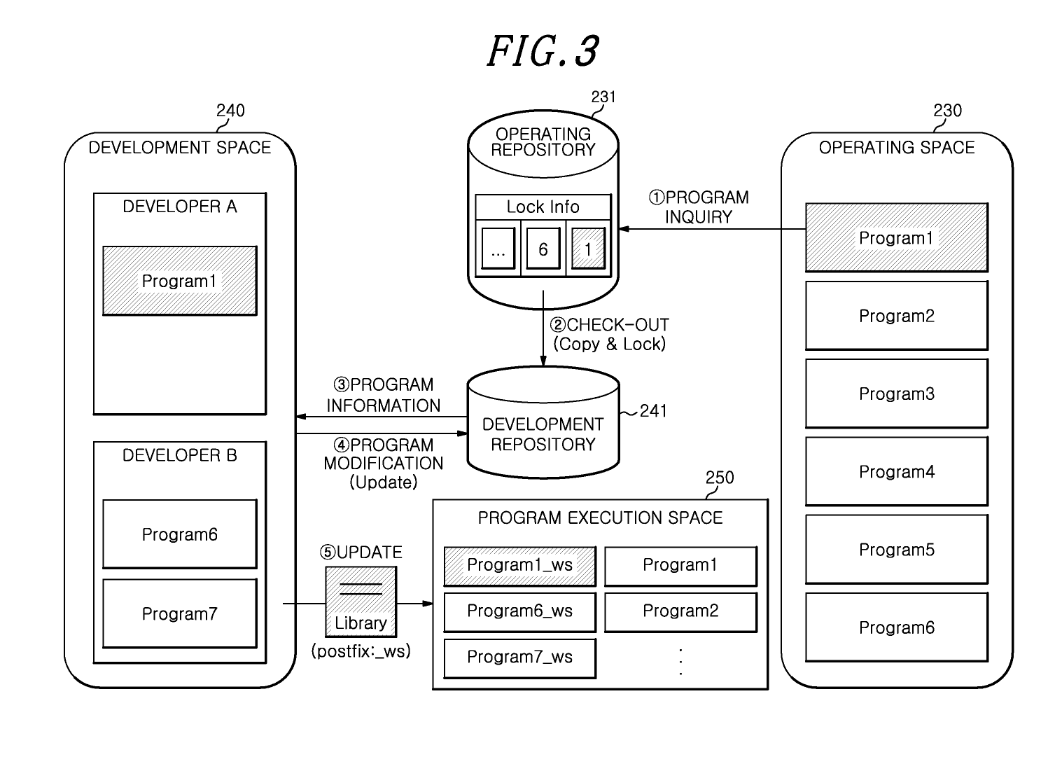

FIG. 3 is a diagram illustrating a process of performing a check-out process on a program in order for a developer to modify the program.

Referring to FIG. 3, in order for a developer to modify a program, a check-out process needs to be first performed. That is, in order to modify a specific program, a target program present in the operating space 230 is checked out to the development space 240. In development, an execution file to be checked out from a program execution space may be distinguished from the same program in an existing operating space using various methods, such as a method of adding a defined prefix or postfix to the execution file or changing the path of the execution file in a check-out process.

First, a check-out process may basically include two operations. The first operation includes a case where a program already present in the operating space 230 is modified and a case where a new program is written.

A first example shows a process when a program 1 present in the operating space 230 is checked out to a developer A (or user A) and the developer A completes the modification of the program 1 and performs an operation of storing the modified program.

When the developer A performs the check-out process on the program 1 in the operating space 230, related check-out information is stored in a place of the operating repository 231 where lock information is managed. All pieces of information (e.g., information about the particulars) about the program 1 are copied to the development repository 241 of the development space 240.

Here, a process of copying the information about the particulars of the program 1 includes a process of inserting all pieces of information for generating a corresponding program into the development repository 241, a process of completing compilation by producing the source of the corresponding program, and a process of uploading (or updating) the corresponding program onto the program execution space 250.

When the developer A modifies (or changes) the program 1, a corresponding histories are accumulated in the development repository 241 based on a point of time at which the program 1 is stored. When the final modification of the program 1 is completed, a file writing rule indicating that a corresponding program is a program of the development space 240 is applied to an execution file written in the corresponding program (e.g., a postfix_ws) and updated into the program execution space 250. Accordingly, the corresponding program can be fetched by another program.

A second example shows a case where a developer writes a new program. In such a case, the remaining processes of FIG. 3 other than a program inquiry process \textcircled{1} are performed in the same manner as the check-out process \textcircled{2} for modifying a program. When writing a new program, however, only a process of setting a lock in the check-out process \textcircled{2} is performed and a process of copying the program to the development repository 241 is omitted. Here, the reason why the lock is set in the program is to manage lock information in order to prevent the name of the same program from being redundantly registered with the development space 240.

That is, in order to achieve a development object of the present invention, the present embodiment illustrates a process of uploading the execution file of a program being developed from the development space to the program execution space. According to such a process, the program 1 has a structure capable of fetching two versions for development and an operation within a single program execution space.

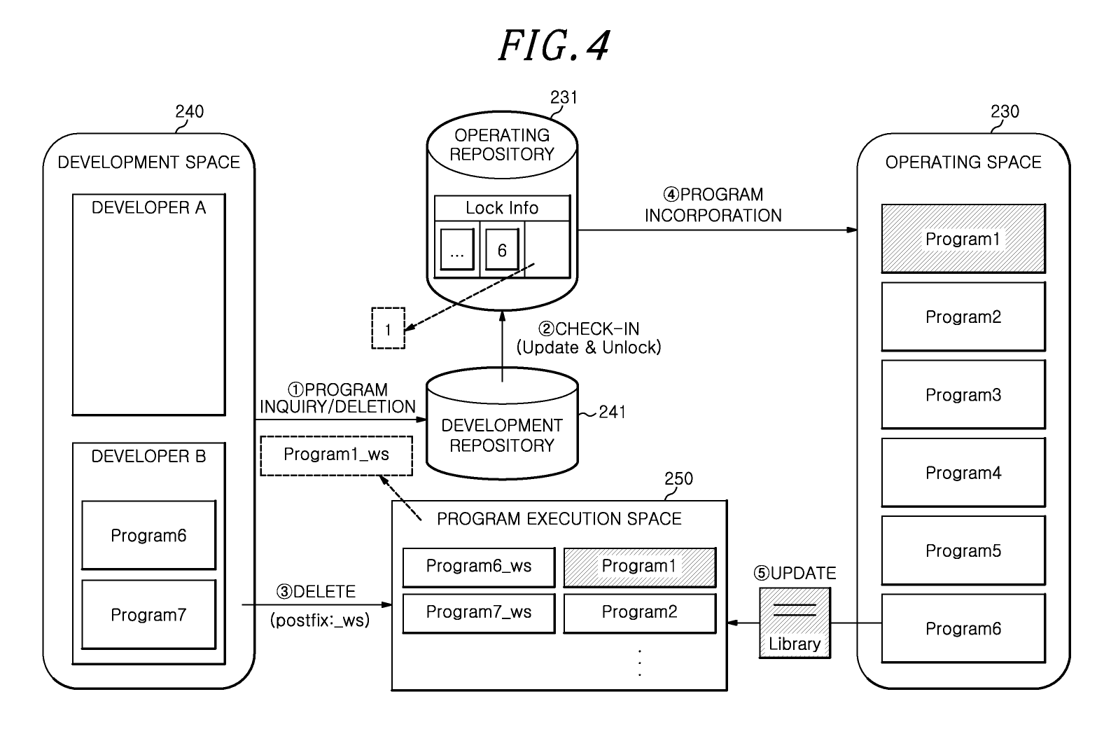

FIG. 4 is a diagram illustrating a process of performing a check-in process for updating a developed or modified program by incorporating the developed or modified program into an operating space.

FIG. 4 illustrates a check-in process of incorporating a program, developed (or modified) in the development space 240, into the operating space 230. When a program is modified (or developed), the modified or developed program is incorporated into the operating space 230 through a check-in process. Here, an execution file used in the development space 240 is deleted from the program execution space 250 (\textcircled{3}), and an existing program present in the operating space 230 is update (\textcircled{5}).

That is, a modified (or developed) program present in the development space 240 is incorporated into the operating space 230 through a check-in process. Thereafter, if the program on which the check-in process has been completed is fetched by the program execution space 250, the program execution file of the operating space 230 becomes a fetch object. For example, when a developer A checks in a program 1, an execution file (e.g., a prefix_ws) ‘program1_ws’ indicating that the program 1 is a program of the development space 230 is deleted from the program execution space 250, and the program 1 is incorporated into the operating space 230 through a check-in process. In the case of a new program not present in the operating space 230, the program 1 is uploaded onto the program execution space 250. If the program 1 present in the operating space 230 is modified, an existing file is updated in the program execution space 250.

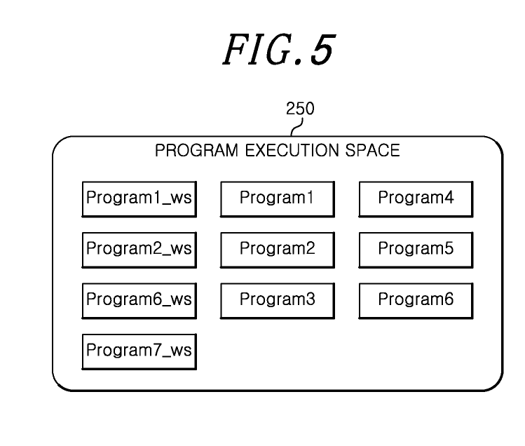

FIG. 5 is a diagram illustrating a state in which programs in the development space and the operating space according to the present invention are logically classified and registered with the program execution space for an operation.

Referring to FIG. 5, a simulation control unit (not shown) for managing simulations (or tests) is present in the program execution space 250. Here, an execution file writing rule used may include the same method as a resource management rule, such as check-out and storage.

That is, in order to achieve the object of the present invention, if a program being developed and a program being driven coexist in a single program execution space, it can be seen from FIG. 5 that programs 1 to 6 corresponding to an operating space and programs 1, 2, 6, and 7 corresponding to a development space are present in a program execution space 250. The programs 1, 2, and 6 corresponding to the development space are redundant programs. It can be seen that the programs 1, 2, and 6 correspond to programs checked out from the programs of the operating space and the program 7 is a newly generated program.

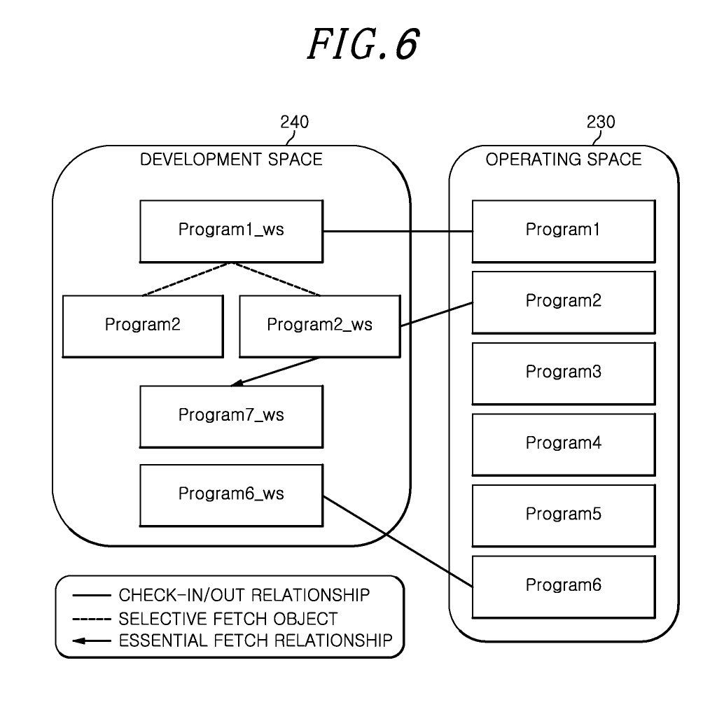

FIG. 6 is a diagram illustrating a case where the operation of a program 2 and a development program are mixed and simulated when a developer modifies the program 2. The name of an execution program present in the execution space is represented. Here, a program 6 indicates that an independent program not having a fetch relationship with other programs is not influenced although it is checked out to the development space. FIG. 6 illustrates that a program 1 is executed in the operating space 230 as a program that fetches a program 2 and a program is written so that the program 2 is modified in the development space 240 and a program 7 newly written by the program 2 can be fetched. In such a case, when the program 1 fetches the program 2, the program 1 can determine whether to select the program present in the operating space 230 or the program 2 present in the development space 240. In such a case, the client can determine that the program 2 will be fetched from which one of the operating space 230 and the development space 240. Accordingly, only when the development space 240 is selected, the newly written program 7 can be fetched.

Furthermore, source code regarding that which program 2 will be fetched from a program execution space is present in the program 1. If a program to be fetched by a client program is determined, the source code of a program1_ws is internally written again and the program 2 present in a selected space is fetched.

In the program 2 of FIG. 6, a dotted line indicates a program to which an operation or development version is selectively applied when performing tests, a solid line indicates a check-in/out relationship, a dotted line indicates a selective fetch object, and an arrow solid line indicates an essential fetch relationship.

That is, in accordance with the present invention, a program being developed and a program being driven are made coexist in a single program execution space so that an existing program can be modified or a new program can be developed.

First, if the existing program is to be modified, when a developer selects a program to be modified, a check-out process of fetching the program from the operating space to the development space is performed, and a modification task is performed on the checked-out program in the development space.

That is, if the check-out process is performed, the program present in the operating space is read by the space management control unit 221. Since the program has been checked out, the program is locked by the program information management unit 225. Next, the space management control unit 221 writes the program into the development space. The execution file control unit 223 produces the execution file of the checked-out program. For example, the execution file control unit 223 classifies the name of the execution file using a delimiter indicative of the development space and puts the execution file into the program execution space.

Furthermore, after the checked-out program is modified, a new version of the modified program is generated. Thus, the program version control unit 222 performs a function (i.e., the existing checked-out version becomes a history and the modified version becomes the latest version), the program information management unit 225 stores the contents of the modified program, and the execution file control unit 223 newly produces an execution file.

When the modification task is completed, the space management control unit 221 checks a target program present in the operating space having a fetch relationship with the modified program, and the simulation control unit 224 changes a selected program so that the selected program can be fetched.

Thereafter, the simulation control unit 224 performs simulations on the modified program through an association (or mixed use) between the modified program and the target program. When program development is completed (or the simulations are completed), the system server 220 can perform a series of processes for performing a check-in process of updating the contents of the modified program by incorporating the modified program into the operating space. After the program is modified through the series of processes, the modified program can be mixed with the target program having a fetch relationship with the modified program and simulated in the development space. As a result, the verified and modified program can be incorporated into the operating space by taking even the fetch relationship into consideration.

Furthermore, if the new program is to be developed, like in the case where the existing program is modified, a developer can perform a series of processes of performing a development task on the new program through the development space, selecting a target program present in the operating space that has a fetch relationship with a developed program when the development task is completed, changing a corresponding program so that the selected target program can be fetched, performing simulations on the developed program through an association between the developed program and the target program, and performing a check-in process of updating the contents of the developed program by incorporating the contents of the developed program into the operating space when program development is completed (or the simulations are completed). When a target program having a fetch relationship with a new program is mixed with the new program and simulated in the development space through the series of processes, a verified new program can be incorporated into the operating space by taking even the fetch relationship into consideration.

As described above, the software development apparatus according to the present invention adopts a structure in which the execution space in which the operating space and the development space coexist is used as a common repository without a conventional development system operation method of additionally managing the program product of the operating space upon development, thereby being capable of improving the productivity of software development.

Furthermore, the present invention can reduce temporal and material costs attributable to the construction of a development environment and a hardware operation which may occur when developing a common program and also present a fundamental solution to a matching problem that may occur due to the management of a program version.

Furthermore, in accordance with the present invention, since an operation or development program can be selectively applied and simulated, the same results as those incorporated into an operation shape can be verified prior to the submission of the results when modifying a program having a fetch relationship.

Furthermore, in the software development apparatus according to the present invention, since a target space is divided into the development space and the operating space, the development history of a program that has been developed and transferred to the operating space is meaningless data. Thus, the developed and transferred program does not affect an operation although a development space repository is deleted if necessary. Accordingly, there is a great advantage in managing program histories that are unlimitedly accumulated as projects are carried out.

The foregoing summary is illustrative only and is not intended to be in any way limiting. In addition to the illustrative aspects, embodiments, and features described above, further aspects, embodiments, and features will become apparent by reference to the drawings and the following detailed description.

While the invention has been shown and described with respect to the preferred embodiments, the present invention is not limited thereto. It will be understood by those skilled in the art that various changes and modifications may be made without departing from the scope of the invention as defined in the following claims.

Accordingly, the scope of the present invention should be interpreted based on the following appended claims, and all technical spirits within an equivalent range thereof should be construed as being included in the scope of the present invention.

1. A software development apparatus, comprising:
a processor configured to:
separately control and manage an operating space that is a space of a previously developed program and a virtual development space to be assigned to a developer;
update contents of a program into the operating space and manage a history of an existing program in a check-in process and control a version of a program in the virtual development space when a checked-out program is modified;
manage names of execution files of the programs of the operating space and the virtual development space using delimiters so that the program of the operating space is distinguished from the program of the virtual development space in a single program execution space;
write a fetch relationship between the programs of the operating space and the virtual development space so that the program of the operating space or the virtual development space is selectively fetched when simulating a program being developed, fetch a target program, and perform a simulation operation on the target program; and
manage information about contents of the program being developed and appended data necessary to control a corresponding program,
wherein the processor changes the fetch relationship so that a 2^{nd} program desired by a 1^{st} program of the operating space can be fetched in order to execute simulations and performs control so that a program present in a target space is selected and fetched.

2. The software development apparatus of claim 1, wherein the processor is further configured to manage a target space as the virtual development space when deleting a program in the virtual development space and manages a target space as the operating space when deleting a lock for the check-in process.

3. The software development apparatus of claim 1, wherein the processor is further configured to control a target space so that a program present in a space selected by a user is fetched when the program of the virtual development space or the operating space is selectively executed for the simulation operation.

4. The software development apparatus of claim 1, wherein the processor is further configured to manage resources of a program through a check-in process and a check-out process and determines a state of a program based on information about a program lock used.

5. The software development apparatus of claim 1, wherein the processor is further configured to add a predefined prefix or postfix to the name of the execution file of the program of the virtual development space or changes a path of the execution file so that the name of the execution file of the program of the virtual development space is distinguished from the name of the execution file of the program of the operating space when writing the program of the development space.

6. The software development apparatus of claim 1, wherein the program being developed is a modification program or a new program.

7. A software development method, comprising:
performing a check-out process of fetching a program to be modified from an operating space to a development space;
performing a modification task on the checked-out program in the development space;
selecting a target program of the operating space having a fetch relationship with the modified program when the modification task is completed;
changing the selected target program so that the selected target program is fetched;
performing simulations on the modified program through an association between the modified program and the target program; and
performing a check-in process of updating contents of the modified program by incorporating the contents of the modified program into the operating space when program development is completed.

8. A software development method, comprising:
performing a development task on a new program through a development space;
selecting a target program of an operating space having a fetch relationship with the developed program when the development task is completed;
changing the selected target program so that the selected target program is fetched;
performing simulations on the developed program through an association between the developed program and the target program; and
performing a check-in process of updating contents of the developed program by incorporating the contents of the developed program into the operating space when program development is completed.
